(19) United States
(12) Patent Application Publication
(10) Pub. No.: US 2023/0262192 A1
(43) Pub. Date: Aug. 17, 2023

(54) VIDEO DISPLAY DEVICE, VIDEO DISPLAY SYSTEM, AND VIDEO DISPLAY METHOD

(71) Applicant: SONY SEMICONDUCTOR SOLUTIONS CORPORATION, KANAGAWA (JP)

(72) Inventor: MIDORI KANAYA, KANAGAWA (JP)

(21) Appl. No.: 18/005,122

(22) PCT Filed: Jun. 7, 2021
(86) PCT No.: PCT/JP2021/021487

§ 371 Date: Jan. 11, 2023

(30) Foreign Application Priority Data
Jul. 21, 2020 (JP) 2020-124441

(51) Int. Cl. H04N 5/74; H04N 5/265; G06T 7/70; G06V 10/145; G02B 27/01

(52) U.S. Cl. CPC H04N 5/74; H04N 5/265; G06T 7/70; G06V 10/145; G02B 27/0172

(57) ABSTRACT

Provided are a video display device, a video display system, and a video display method that prevent leakage of personal information or confidential information and reduce a burden on a user. The present technology provides a video display device including a video projection unit configured to obtain identification information for identifying a user and position information including a position of a head of the user and project video light associated with the identification information toward the position, and provides a video display system including a video projection unit configured to obtain identification information for identifying a user and position information including a position of a head of the user and project video light associated with the identification information toward the position, and an eyepiece optical unit including an optical element configured to concentrate the video light to project the video light onto a pupil of the user, with the video projection unit and the eyepiece optical unit disposed separately from each other.

### TECHNICAL FIELD

The present technology relates to a video display device, a video display system, and a video display method.

### BACKGROUND ART

For example, a digital signage device that displays a video (including, for example, an image or a character) using a display, a projector, or the like is used.

For example, Patent Document 1 discloses “An information processing device including an application information acquisition unit which acquires a position of a window on a display screen, and a control unit which terminates an application of a window whose position acquired by the application information acquisition unit satisfies a predetermined condition”. In Patent Document 1, a technology for determining a user's preference by a machine learning method and presenting recommended content or the like to the user.

Furthermore, a head mounted display (HMD) that projects video light onto a pupil of a user to allow the user to visually recognize a video, and the like have also been used.

For example, Patent Document 2 discloses “An image display apparatus including a modulated light output part which outputs modulated light which is modulated according to an image information; a scanning part which outputs the modulated light outputted from the modulated light output part as scanning light; and a transfer optical system which is provided at the rear stage of the scanning part and guides the scanning light to the pupil of an observer. The image display apparatus is characterized by being provided with: a head-mount part which is mounted on the head of the observer, in which at least a part of the transfer optical system among the scanning part and the transfer optical system is provided; and a body-carrying part mounted on the body of the observer to be carried, in which at least the modulated light output part among the modulated light output part and the scanning part is provided”.

### CITATION LIST

### Patent Document

Patent Document 1: Japanese Patent Application Laid-Open No. 2015-114970
Patent Document 2: Japanese Patent Application Laid-Open No. 2005-309264

### SUMMARY OF THE INVENTION

### Problems to be Solved by the Invention

If the digital signage device used in Patent Document 1 and the like is provided as an infrastructure in a facility or the like, it is advantageous because a user need not carry a video display device. However, when the digital signage device displays personal information, confidential information, or the like regarding the user, there is a possibility that another person steals a glance at such personal information.

In the head mounted display used in Patent Document 2 and the like, the head-mount part includes a drive unit, so that there is a problem that a burden on the user is large.

It is therefore a main object of the present technology to provide a video display device, a video display system, and a video display method that prevent leakage of personal information or confidential information and reduce a burden on a user.

### Solutions to Problems

The present technology provides a video display device including a video projection unit configured to obtain identification information for identifying a user and position information including a position of a head of the user and project video light associated with the identification information toward the position.

The video light may be projected onto a pupil of the user.

The video light may be coherent light.

The video light may be laser light.

The video projection unit may obtain the position information on the basis of a captured image including the user.

The video projection unit may obtain the position information on the basis of a difference between a transmission time of infrared light transmitted toward the user and a reception time of the infrared light reflected.

The video projection unit may adjust, on the basis of the position information, an angle of an optical axis of the video light and project the video light.

The video display device may further include an eyepiece optical unit including an optical element configured to concentrate the video light to project the video light onto the pupil of the user.

The eyepiece optical unit may include a tag including the identification information.

The optical element may include a diffraction grating configured to diffract the video light.

The optical element may be positioned on the optical axis of the video light.

The eyepiece optical unit may be mounted on the head of the user.

The eyepiece optical unit may be carried by the user.

The video projection unit may adjust, on the basis of characteristic information regarding characteristics of the optical element, the angle of the optical axis of the video light and project the video light.

The video projection unit may include a video display unit configured to display a video on a screen, and a virtual image reproduced by the video light projected onto the pupil of the user may be displayed with the virtual image superimposed on the screen.

The present technology further provides a video display system including a video projection unit configured to obtain identification information for identifying a user and position information including a position of a head of the user and project video light associated with the identification information toward the position, and an eyepiece optical unit including an optical element configured to concentrate the video light to project the video light onto a pupil of the user, with the video projection unit and the eyepiece optical unit disposed separately from each other.

Each of a plurality of the video projection units may be connected over an information communication network, and the identification information and/or information regarding the video light may be communicated over the information communication network.

The present technology further provides a video display method including obtaining identification information for identifying a user and position information including a position of a head of the user and projecting video light associated with the identification information toward the position.

### BRIEF DESCRIPTION OF DRAWINGS

FIG. 1 is a conceptual diagram of a video display device 10 according to an embodiment of the present technology.

FIG. 2 is a block diagram illustrating a configuration of a video projection unit 1 according to the embodiment of the present technology.

FIG. 3 is a flowchart illustrating an example of a procedure of a control unit 17 according to the embodiment of the present technology.

FIG. 4 is a conceptual diagram of the video display device 10 according to the embodiment of the present technology.

FIG. 5 is a schematic diagram of an eyepiece optical unit 2 according to the embodiment of the present technology.

FIG. 6 is a schematic diagram for describing a function of the video projection unit 1 according to the embodiment of the present technology.

FIG. 7 is a schematic diagram of the eyepiece optical unit 2 according to the embodiment of the present technology.

FIG. 8 is a flowchart illustrating an example of the procedure of the video projection unit 1 according to the embodiment of the present technology.

FIG. 9 is a conceptual diagram of the video display device 10 according to the embodiment of the present technology.

FIG. 10 is a conceptual diagram of a video display system 1000 according to the embodiment of the present technology.

FIG. 11 is a block diagram illustrating a configuration of the video display system 1000 according to the embodiment of the present technology.

FIG. 12 is a flowchart illustrating an example of a procedure of a video display method according to the embodiment of the present technology.

### MODE FOR CARRYING OUT THE INVENTION

Hereinafter, preferred embodiments for carrying out the present technology will be described. The embodiments to be described below are examples of a representative embodiment of the present technology, and the scope of the present technology is not restrictively interpreted by the embodiments. Furthermore, the conceptual diagrams and the schematic diagrams are not necessarily illustrated in a strict manner.

The present technology will be described in the following order.

1. First embodiment of present technology (first example of video display device)

2. Second embodiment of present technology (second example of video display device)

3. Third embodiment of present technology (third example of video display device)

4. Fourth embodiment of present technology (fourth example of video display device)

5. Fifth embodiment of present technology (fifth example of video display device)

6. Sixth embodiment of present technology (first example of video display system)

7. Seventh embodiment of present technology (second example of video display system)

8. Eighth embodiment of present technology (video display method)

9. Example of the present technology

### 1. First Embodiment of Present Technology (First Example of Video Display Device)

### [(1) Outline of Present Embodiment]

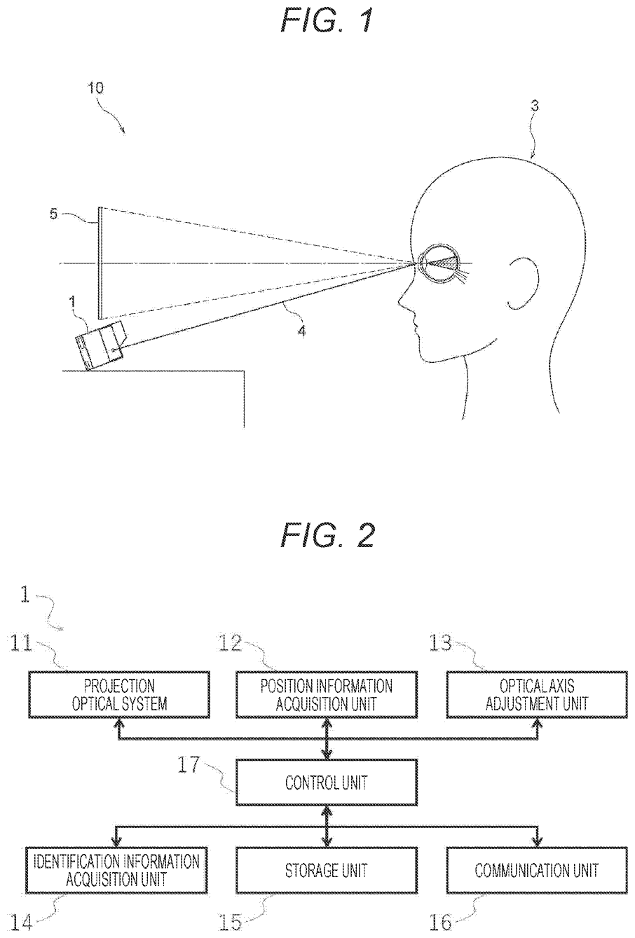

A video display device 10 according to an embodiment of the present technology will be described with reference to FIG. 1. FIG. 1 is a conceptual diagram of the video display device 10 according to the embodiment of the present technology. As illustrated in FIG. 1, the video display device 10 according to the present embodiment includes a video projection unit 1.

The video projection unit 1 can be positioned below a user's line-of-sight. Note that the video projection unit 1 may be positioned above the user's line-of-sight.

The video projection unit 1 projects video light 4 toward a head of a user 3. The video light 4 is associated with the user 3, so that the video light 4 may be different for each user 3. The video projection unit 1 can associate the video light 4 with the user 3 using identification information for identifying the user 3.

The video projection unit 1 obtains position information including a position of a head of the user using, for example, a camera, a photodetector, or the like. The video projection unit 1 can therefore project video light 4 toward the head of the user 3.

More specifically, the video light 4 may be projected onto a pupil of the user 3. The video light 4 projected onto the pupil forms an image on a retina of the user 3. As a result, a virtual image 5 appears in the air.

As a technique for forming a video on a retina, for example, a Maxwell optical system, a laser scanning optical system, or the like can be used. The Maxwell optical system is a system that causes video light to pass through the center of a pupil to form an image on a retina. The laser scanning optical system is a system that scans red light, green light, and blue light at high speed to draw a video on the retina. The laser scanning optical system is not affected by a video resolution, and can bring the video as close as possible to the human field of view.

A deterioration in focus adjustment function of a crystalline lens serving as a lens causes a problem such as myopia or hyperopia. In the present technology, however, the video is directly projected onto a retina, so that the user 3 can visually recognize a clear video. The video visually recognized by the user 3 is displayed as the virtual image 5. The user 3 can visually recognize both the virtual image 5 and a background of the virtual image 5 that are in focus at the same time.

A digital signage device using a display such as a liquid crystal display or an organic EL display has been widely used. Such a digital signage device is used for, for example, advertisement activities or information provision. The digital signage device can provide, to the user, a video regarding the user, for example.

At this time, the video provided to the user may include personal information, confidential information, or the like regarding the user. For example, in a case where the digital signage device is installed in a bank, numbers for prompting the user to enter an account number may be included in the video provided to the user. Furthermore, for example, in a case where the digital signage device is installed in a hospital, the content to be entered in a medical questionnaire may be included in the video to be provided to the user. Therefore, there is a problem that another person may steal a glance at such personal information or confidential information.

In order to solve this problem, the video projection unit 1 according to the present embodiment obtains identification information for identifying the user 3 and position information including the position of the head of the user 3, and projects the video light 4 associated with the identification information toward the position (the head of the user 3). Only the user 3 can visually recognize a video formed by the video light 4, so that the video display device 10 can prevent a person other than the user 3 from stealing a glance at the video. Therefore, in a case where the video includes personal information or confidential information regarding the user 3, video display device 10 can prevent leakage of the personal information or the confidential information.

The video projection unit 1 is provided as an infrastructure, for example, and can be installed in a facility or the like. This eliminates the need for the user 3 to carry the video projection unit 1, so that a burden on the user 3 is reduced. There is no concern about power consumed by the video projection unit 1 for the user 3.

Furthermore, in a case where the user 3 carries the video projection unit 1, the video projection unit 1 performs information communication using a communication technology such as Wi-Fi or long term evolution (LTE), for example. At this time, there is a possibility that radio waves become unstable, and communication cannot be performed. On the other hand, if the video projection unit 1 is installed in a facility or the like as an infrastructure, a stable information communication network can be constructed. As a result, the video projection unit 1 can access video data as the source of the video light 4 at a high speed, and can provide a clear and high-resolution video.

As described above, the video display device 10 can more safely and easily provide, to the user, an unprecedented new video experience.

Furthermore, personal information, confidential information, or the like regarding the user 3 can be accumulated and effectively utilized.

Note that the above-described effects can also be obtained by other embodiments to be described later. Therefore, for the other embodiments, no description will be given of the effects.

### [(2) Video Projection Unit]

A configuration of the video projection unit 1 according to the embodiment of the present technology will be described with reference to FIG. 2. FIG. 2 is a block diagram illustrating the configuration of the video projection unit 1 according to the embodiment of the present technology. As illustrated in FIG. 2, the video projection unit 1 according to the embodiment of the present technology can include, for example, a projection optical system 11, a position information acquisition unit 12, an optical axis adjustment unit 13, an identification information acquisition unit 14, a storage unit 15, a communication unit 16, and a control unit 17.

The projection optical system 11 that projects video light can include, for example, a light source unit (not illustrated) that outputs the video light, and an optical scanning unit (not illustrated) that two-dimensionally scans the output video light. The video light output from the light source unit can be intensity-modulated on the basis of on video data stored in the storage unit 15 or the like, for example, and can be output as a light flux including red light, green light, and blue light, for example. The optical scanning unit may include, for example, a MEMS mirror. The optical scanning unit can change a direction of the video light output from the light source unit at a high speed so as to form a video on the retina.

More specifically, the projection optical system 11 can display a two-dimensional image by changing, on a dot-by-dot basis, a color of the video light output from the light source unit while changing, on a dot-by-dot basis, an angle of the MEMS mirror included in the optical scanning unit, for example.

The video light projected by the projection optical system 11 may be coherent light. The coherent light has a characteristic of having parallel rays and spreading minimally. This produces an effect that the virtual image 5 is easily in focus at any distance from the eye of the user 3.

Note that the video light output from the light source unit need not necessarily be ideal coherent light. The video light may be, for example, laser light. The laser light has a strong resemblance to the coherent light, and has a characteristic of having parallel rays and spreading minimally. This produces an effect that the virtual image 5 is easily in focus at any distance from the eye of the user 3. This can be realized by using a semiconductor laser (LD: Laser Diode) for the light source unit.

According to a preferred embodiment of the present technology, for example, a light emission diode (LED) or the like may be used for the light source unit.

According to the preferred embodiment of the present technology, the projection optical system 11 may project different video light onto each of the eyes of the user 3. For example, the projection optical system 11 can project different video light onto each of the eyes on the basis of binocular parallax of the user 3. As a result, for example, the user can recognize a three-dimensional position of the presented video, for example, by binocular vision. For example, a three-dimensional virtual image 5 appears in an outside scene the user is viewing.

The position information acquisition unit 12 obtains position information including the position of the head of the user 3. This allows the video light to be projected toward the position of the head of the user 3.

The position information acquisition unit 12 can include, for example, an image sensor or the like. As the image sensor, for example, a CMOS or a CCD may be used. A captured image including the user 3 is acquired by the image sensor. That is, in the present technology, the position information acquisition unit 12 can obtain the position information regarding the head of the user 3 on the basis of the captured image obtained by the image sensor included in the position information acquisition unit 12.

The captured image may include an image of the eye of the user 3. This allows the position information acquisition unit 12 to obtain three-dimensional position information of the eye by processing the captured image. Note that the position information acquisition unit 12 can obtain the three-dimensional position information using pupil recognition technology. As the pupil recognition technology, a technology known in the art may be used.

The optical axis adjustment unit 13 can adjust the angle of the optical axis of the video light on the basis of the position information obtained by the position information acquisition unit 12. This allows, even if the position of the head of the user 3 is changed, the video light to be projected onto the head of the user 3 by following the position of the head. Note that the optical axis adjustment unit 13 may be included in the projection optical system 11.

The optical axis adjustment unit 13 can include, for example, a galvano scanner. The galvano scanner can include a galvano mirror capable of reflecting video light in a specific direction, a motor that adjusts an angle of the galvano mirror, and a motor control unit that controls the motor. The motor can include, for example, a voice coil motor, a DC motor, a stepping motor, or the like. The motor control unit can include, for example, a microcomputer on which firmware is installed.

The identification information acquisition unit 14 obtains the identification information for identifying the user. This allows the user to visually recognize the video associated with the user.

The identification information acquisition unit 14 can include, for example, a touchscreen. The touchscreen can prompt the user to enter an identification number.

The storage unit 15 can store video data regarding a video that is visually recognized by the user. Moreover, the video data is stored with the video data associated with the identification information for identifying the user. Specifically, for example, the identification information may be included in a file name of the video data, or a database management system (DBMS) or the like may be used.

The storage unit 15 can be implemented by, for example, a hard disk drive (HDD) or a solid state drive (SSD).

The communication unit 16 has a function of performing communication over an information communication network using a communication technology such as Wi-Fi, Bluetooth (registered trademark), or long term evolution (LTE), for example. This allows the video projection unit 1 to acquire, for example, video data, identification information, or the like stored in a computer device other than the video projection unit 1 over the information communication network.

The control unit 17 can control the operation of the components included in the video projection unit 1. The control unit 17 can be implemented by, for example, a microcomputer or the like.

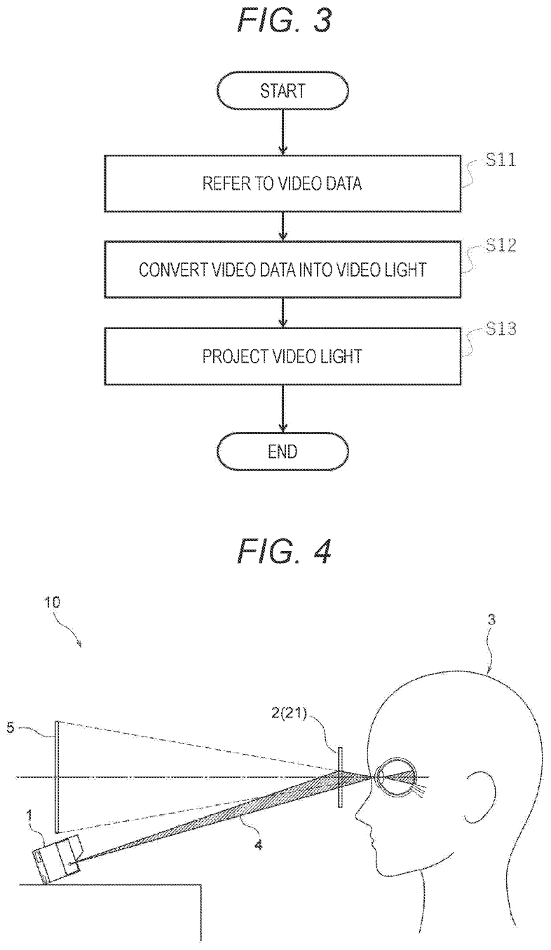

A procedure of the control unit 17 will be described with reference to FIG. 3. FIG. 3 is a flowchart illustrating an example of the procedure of the control unit 17 according to the embodiment of the present technology.

As illustrated in FIG. 3, first, in step S11, the control unit 17 refers to, on the basis of the identification information obtained by the identification information acquisition unit 14, video data associated with the identification information stored in the storage unit 15 or the like.

Next, in step S12, the control unit 17 instructs the projection optical system 11 to convert the video data into video light.

Finally, in step S13, the control unit 17 instructs the projection optical system 11 to project the video light toward a position obtained by the position information acquisition unit 12.

### 2. Second Embodiment of Present Technology (Second Example of Video Display Device)

A video display device 10 according to an embodiment of the present technology will be described with reference to FIG. 4. FIG. 4 is a conceptual diagram of the video display device 10 according to the embodiment of the present technology. As illustrated in FIG. 4, the video display device 10 according to the present embodiment can further include an eyepiece optical unit 2 including an optical element 21 that concentrates video light to project the video light onto the pupil of the user 3.

The eyepiece optical unit 2 can be mounted on the head of the user 3. An embodiment of the eyepiece optical unit 2 may include, for example, glasses, goggles, a helmet, and the like.

The optical element 21 included in the eyepiece optical unit 2 is separated from the video projection unit 1 and is disposed in front of the eye of the user 3. That is, the optical element 21 is disposed on the optical axis of the video light. The video light projected from the video projection unit 1 reaches the eye of the user 3 through the optical element 21. The video light passes through the pupil of the user 3 and forms an image on the retina. As a result, a virtual image 5 appears in the air. Since the video light forms an image on the retina, even in a case where the pupil or the optical element 21 is displaced, the field of view is easily secured, and the image hardly disappears.

The optical element 21 may be, for example, a hologram lens or the like. The optical element 21 may include a diffraction grating that diffracts the video light projected from the video projection unit 1. The diffraction grating is used to diffract the video light projected from the video projection unit 1 to reach the eye of the user 3.

More specifically, the video light projected from the video projection unit 1 is changed in direction by the optical element 21 to reach the eye of the user 3. The user can therefore visually recognize the video formed by the video light from the video projection unit 1 with the video projection unit 1 not positioned on the line-of-sight of the user 3.

Note that, according to another embodiment of the present technology, the video projection unit 1 may be positioned at almost the same height as the line-of-sight of the user 3. In this case, for example, limiting the position where the video is displayed or the like to a part (for example, an upper half, a lower half, a left half, a right half, or the like) of the field of view of the user 3 can prevent the user from feeling bothered due to an overlap between the video projection unit 1 and the outside scene.

Preferably, the optical element 21 can have an optical characteristic that causes the optical element 21 to function as a lens for light in a wavelength range of the video light and to transmit light having a wavelength that falls outside the wavelength range. Such an optical characteristic allows the user 3 to visually recognize, for example, a scene ahead of the user's line-of-sight through the optical element 21 and to visually recognize a video formed by the video light. Furthermore, since the optical element 21 has the optical characteristic, in a case where video projection is not performed, the eyepiece optical unit 2 can be used as the eyepiece optical unit 2 itself, for example, as glasses.

Examples of the optical element 21 having the above-described optical characteristic include a hologram lens, preferably a film-shaped hologram lens, and more preferably a transparent film-shaped hologram lens. A desired optical characteristic can be imparted to the hologram lens using a technique known in the art. As the hologram lens, a commercially available hologram lens may be used, or the hologram lens may be manufactured using a technique known in the art.

For example, the hologram lens can be placed, as the optical element 21, on one surface of the lens included in the eyepiece optical unit 2. The surface may be a surface adjacent to the outside scene or a surface adjacent to the eyeballs. Attaching the optical element 21 to the eyepiece optical unit 2 appropriately selected by the user or a person skilled in the art makes the video display device 10 according to the present technology available. Therefore, the range of selection of the eyepiece optical unit 2 that can be employed in the present technology is very wide.

Note that the optical element 21 only needs to refract the video light, so that, for example, a generally used convex lens or the like may be used for the optical element 21. The convex lens, however, makes it difficult for the user 3 to visually recognize a scene ahead of the line-of-sight of the user 3, so that it is more preferable to use a hologram lens.

Note that although the optical element 21 refracts the video light in FIG. 4, the video light may directly reach the eye of the user 3 without passing through the optical element 21 in the present technology. For example, this can be achieved by the video projection unit 1 including a lens part having a long F.

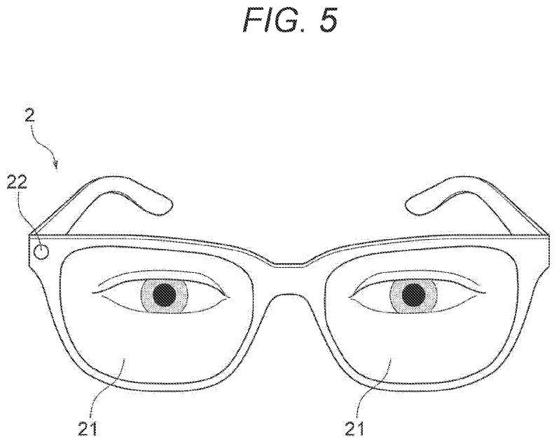

The video display device 10 can identify the user using the eyepiece optical unit 2. This will be described with reference to FIG. 5. FIG. 5 is a schematic diagram of the eyepiece optical unit 2 according to the embodiment of the present technology. As illustrated in FIG. 5, the eyepiece optical unit 2 can include the optical element 21 that concentrates video light to project the video light onto the user's pupil, and a tag 22 including the identification information for identifying the user. Since the eyepiece optical unit 2 includes the tag 22, the video projection unit 1 can project the video light associated with the user to the user.

A type of the tag 22 can be freely selected in accordance with a concept of the video display device 10. The tag 22 may be, for example, a code or an IC tag (RF tag). The code may be, for example, a barcode, a two-dimensional code, a three-dimensional code, a code represented by colors, or the like. Examples of the IC tag include a passive tag that has no battery but converts a received radio wave into power to work, an active tag that has a battery and transmits a radio wave to obtain information, and a semi-active tag that is a hybrid of the passive tag and the active tag. Moreover, a printed IC tag that is an IC tag printed on the eyepiece optical unit 2 may be used. It is therefore possible to improve the design of the eyepiece optical unit 2.

The video projection unit 1 can include the identification information acquisition unit 14 for reading the tag 22. The identification information acquisition unit 14 may be a reader that reads a code, an IC tag, or the like, for example, as used in a point of sale (POS) system.

Note that the IC tag establishes communication even when the IC tag is apart from the reader as compared with a code. Therefore, the user 3 only needs to get close to the video projection unit 1 to some extent.

The position information acquisition unit 12 that acquires the position of the user can acquire, for example, a captured image including the eyepiece optical unit 2. When the eyepiece optical unit 2 is, for example, of a glasses type, the captured image may include, for example, a frame of the glasses, a mark (not illustrated) attached to the glasses, and the like. The position information acquisition unit 12 can therefore acquire three-dimensional position information regarding the eye of the user 3 by processing the captured image.

The number of the marks may be, for example, one, two, three, four, or more. The use of the plurality of marks allows more accurate three-dimensional position information to acquired. The position of the mark may be selected to be inconspicuous. It is therefore possible to improve the design of the eyepiece optical unit 2.

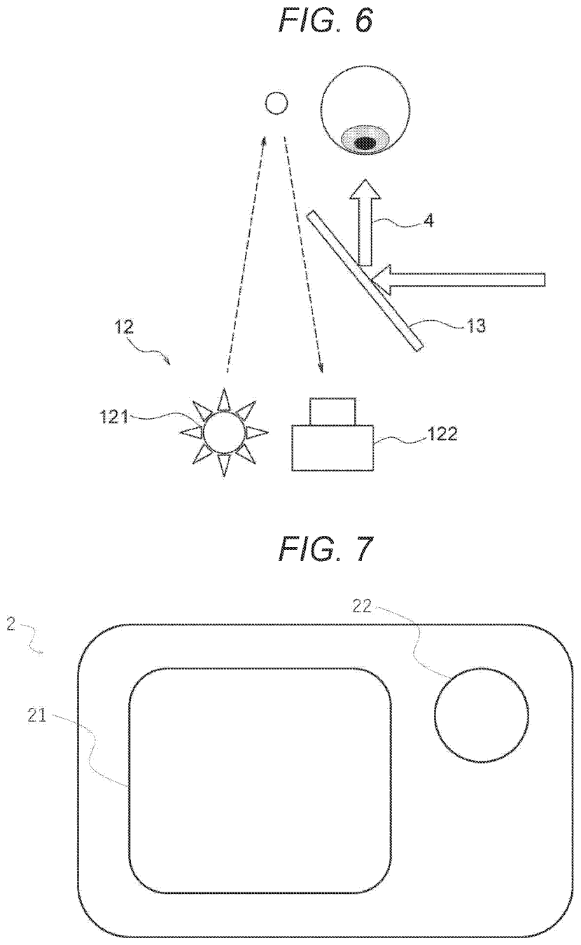

Alternatively, the position information acquisition unit 12 may acquire the three-dimensional position information regarding the eyepiece optical unit 2 using time-of-flight (TOF) technology. This will be described with reference to FIG. 6. FIG. 6 is a schematic diagram for describing a function of the video projection unit 1 according to the embodiment of the present technology.

As illustrated in FIG. 6, the position information acquisition unit 12 can further include a transmission unit 121 and a reception unit 122. First, for example, infrared light is projected toward the user from the transmission unit 121 serving as a light source. This infrared light is reflected off the eyepiece optical unit 2 or the like worn by the user and received by the reception unit 122. The position information acquisition unit 12 obtains the three-dimensional position information regarding the eyepiece optical unit 2 on the basis of a difference between a transmission time of the infrared light transmitted toward the user and a reception time of the reflected infrared light. The three-dimensional position information can be calculated on the basis of the difference and the speed of the infrared light.

The optical axis adjustment unit 13 can adjust the angle of the optical axis of the video light 4 on the basis of the three-dimensional positional information regarding the eyepiece optical unit 2. The video light 4 can be therefore projected onto the pupil of the user.

The eyepiece optical unit 2 need not include a projection optical system. Moreover, the eyepiece optical unit 2 need not include, for example, the projection optical system, a power supply, and a device driven by electric power, which are components necessary for projecting video light. The eyepiece optical unit 2 can be therefore reduced in size and/or weight. As a result, a burden on the user is reduced.

Furthermore, since the components necessary for projecting the video light need not be included, a manufacturing cost of the eyepiece optical unit 2 can be reduced, and a degree of freedom of the design of the eyepiece optical unit 2 increases accordingly. Moreover, the video projection unit 1 that is high in manufacturing cost is provided as an infrastructure, and the eyepiece optical unit 2 that is low in manufacturing cost is purchased or distributed, thereby making the entire cost of the video display device 10 lower. As a result, the video display device 10 can be widely used.

### 3. Third Embodiment of Present Technology (Third Example of Video Display Device)

Another embodiment of the eyepiece optical unit 2 will be described with reference to FIG. 7. FIG. 7 is a schematic diagram of an eyepiece optical unit 2 according to the embodiment of the present technology.

As illustrated in FIG. 7, the eyepiece optical unit 2 according to the present embodiment may be similar in size and shape to a credit card, for example. The eyepiece optical unit 2 can include an optical element 21 that concentrates video light to project the video light onto the user's pupil, and a tag 22 including identification information for identifying the user. As the optical element 21 and the tag 22, the optical element 21 and the tag 22 described in the second embodiment can be used.

The eyepiece optical unit 2 according to the present embodiment can be carried by the user. The user can hold the eyepiece optical unit 2 so as to position the optical element 21 in front of the eye. The user can therefore visually recognize the video formed by the video light.

As described above, the hologram lens as the optical element 21 can be placed on one surface of the lens of the eyepiece optical unit 2. The optical element 21 is attached to the eyepiece optical unit 2 appropriately selected by the user or a person skilled in the art, so that the range of selection of the eyepiece optical unit 2 that can be employed in the present technology is very wide. The eyepiece optical unit 2 may be similar in size and shape to a credit card as in the present embodiment, or may be similar in size and shape to a fan, for example. The form of the eyepiece optical unit 2 is not limited to a specific form, and can be appropriately selected. The eyepiece optical unit 2 whose manufacturing cost is low can be purchased or distributed to the user.

### 4. Fourth Embodiment of Present Technology (Fourth Example of Video Display Device)

The optical element 21 included in the eyepiece optical unit 2 may have unique variations at the time of manufacture or use. In order to reduce the variations produced at the time of manufacturing the eyepiece optical unit 2, a large restriction is required, and as a result, the eyepiece optical unit 2 becomes high in cost. Furthermore, for example, the eye position differs among users, so that when the eyepiece optical unit 2 is used, the optical element 21 and the eye are misaligned with each other. Such variations cause a problem that the video light is not accurately projected to the pupil.

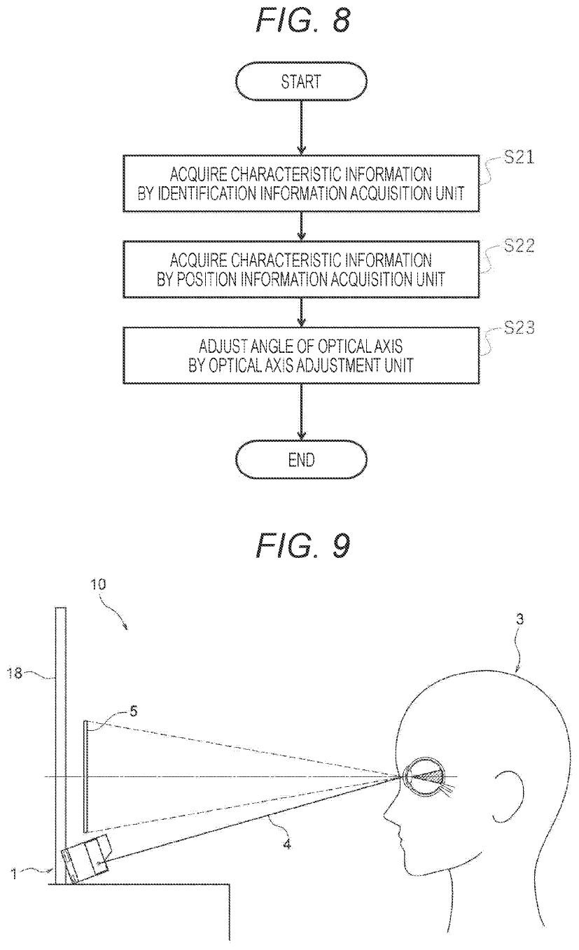

In order to solve this problem, the video projection unit 1 may adjust the angle of the optical axis of the video light on the basis of characteristic information regarding characteristics (information regarding variations) of the optical element 21. This will be described with reference to FIG. 8. FIG. 8 is a flowchart illustrating an example of the procedure of the video projection unit 1 according to the embodiment of the present technology.

As illustrated in FIG. 8, first, in step S21, the identification information acquisition unit 14 included in the video projection unit 1 acquires the characteristic information regarding the characteristics of the optical element 21. The characteristic information includes, for example, information regarding a focal length, a degree of refraction of each of red light, green light, and blue light, and the like.

The video display device 10 according to the present technology needs to adjust the focal length so as not to be affected by the focus adjustment function of the user's crystalline lens. Furthermore, red light, green light, and blue light each need to be accurately refracted.

The video projection unit 1 can adjust the angle of the optical axis of the video light on the basis of characteristic information regarding the focal length, the degree of refraction of light, and the like. The characteristic information can be included in the tag 22 included in the eyepiece optical unit 2. The identification information acquisition unit 14 included in the video projection unit 1 can acquire the characteristic information by reading the tag 22.

Next, in step S22, the position information acquisition unit 12 included in the video projection unit 1 acquires the characteristic information regarding the characteristics of the optical element 21. The characteristic information includes, for example, information regarding a degree of misalignment between the optical element 21 and the eye.

For example, for example, the eye position differs among users, so that when the same eyepiece optical unit 2 is distributed to a plurality of users, an adjustment for removing the misalignment between the optical element 21 and the eye is required.

The video projection unit 1 can adjust the angle of the optical axis of the video light on the basis of the information regarding the position of optical element 21 and the position of the eye. The characteristic information is obtained, for example, by processing a captured image.

Finally, in step S23, the optical axis adjustment unit 13 included in the video projection unit 1 adjusts the angle of the optical axis of the video light on the basis of the characteristic information regarding the characteristics of the optical element 21 and projects the video light.

As described above, information regarding the variations of the optical element 21 is fed back to the video projection unit 1 so as to correct the angle of the optical axis of the video light. As a result, the video display device 10 increases in performance.

### 5. Fifth Embodiment of Present Technology (Fifth Example of Video Display Device)

The video projection unit 1 can include a video display unit that displays a video on a screen. This will be described with reference to FIG. 9. FIG. 9 is a conceptual diagram of a video display device 10 according to the embodiment of the present technology.

As illustrated in FIG. 9, the video projection unit 1 according to the present embodiment includes a video display unit 18 that displays a video on a screen. The video projection unit 1 projects video light 4 onto the head of the user 3. A virtual image 5 reproduced by the video light 4 projected onto the pupil of the user 3 is displayed with the virtual image 5 superimposed on the screen of the video display unit 18.

Note that, according to a preferred embodiment of the present technology, the video display device 10 may further include an eyepiece optical unit (not illustrated) described in the other embodiments.

Furthermore, the video display unit 18 may be disposed separately from the video projection unit 1.

The virtual image 5 includes a video associated with the user. A common video that is not associated with the user is displayed on the video display unit 18. The video associated with the user and the video not associated with the user are displayed with both the videos superimposed on each other. The video display device 10 can therefore flexibly change a video in a manner that depends on the user. Furthermore, the video display device 10 can prevent another person from stealing a glance at the video.

For example, a map of a certain place is displayed on the video display unit 18. A destination of the user is displayed on the virtual image associated with the user. The map of the certain place and the destination of the user are displayed with the map and the destination superimposed on each other. The user can therefore reach the destination with any other person prevented from knowing the destination.

### 6. Sixth Embodiment of Present Technology (First Example of Video Display System)

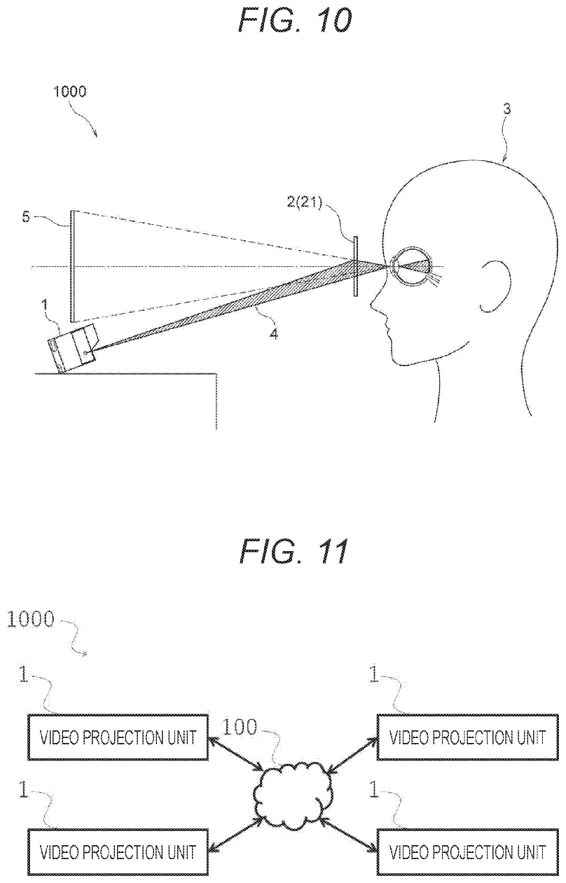

A video display system according to an embodiment of the present technology will be described with reference to FIG. 10. FIG. 10 is a conceptual diagram of a video display system 1000 according to the embodiment of the present technology. Note that the video display system 1000 according to the embodiment of the present technology can use the technology according to the other embodiments described above. Therefore, components that are similar in functionality to the components of the other embodiments are denoted by similar names and reference numerals, and no detailed description of such components will be given.

As illustrated in FIG. 10, the video display system 1000 according to the embodiment of the present technology includes a video projection unit 1 and an eyepiece optical unit 2. The video projection unit 1 obtains identification information for identifying a user 3 and position information including a position of a head of the user 3, and projects video light associated with the identification information toward the position. The eyepiece optical unit 2 includes an optical element that concentrates the video light to project the video light onto a pupil of the user 3. The video projection unit 1 and the eyepiece optical unit 2 are disposed separately from each other.

### 7. Seventh Embodiment of Present Technology (Second Example of Video Display System)

A plurality of video projection units according to an embodiment of the present technology may be connected over an information communication network. This will be described with reference to FIG. 11. FIG. 11 is a block diagram illustrating a configuration of a video display system 1000 according to the embodiment of the present technology.

As illustrated in FIG. 11, a plurality of video projection units 1 is connected over an information communication network 100. The video projection units 1 are provided as, for example, an infrastructure, and can be installed in, for example, a public facility.

The information communication network 100 can be implemented by, for example, a wired network such as a local area network (LAN) or a wide area network (WAN), a wireless network such as a wireless local area network (WLAN) or a wireless wide area network (WWAN) via a base station, the Internet using a communication protocol such as transmission control protocol/Internet protocol (TCP/IP), or the like.

The identification information and/or information regarding the video light can be communicated over the information communication network 100. The information regarding the video light may be, for example, video data. It is therefore possible for the user to visually recognize the video at any place where the video projection unit 1 is installed. Furthermore, this video can be updated as needed.

Note that the number of video projection units 1 is not limited to a specific number. Furthermore, there may be a video projection unit 1 that is not connected to the information communication network 100.

Note that the video display system 1000 according to the present embodiment may include, for example, a computer device (not illustrated) such as a server. The computer device can store the identification information and/or the information regarding the video light, and can provide the identification information and/or the information regarding the video light to the video projection unit 1 over the information communication network 100.

The computer device may be, for example, a camera, a projector, a smartphone terminal, a tablet terminal, a mobile phone terminal, a personal digital assistant (PDA), a personal computer (PC), a portable music player, a portable gaming console, a POS system, or a wearable terminal (for example, a head mounted display (HMD), a glasses-type HMD, a watch-type terminal, a band-type terminal, or the like).

### 8. Eighth Embodiment of Present Technology (Video Display Method)

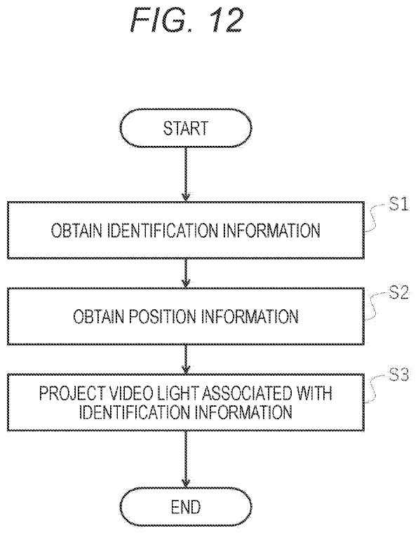

A video display method according to an embodiment of the present technology is implemented via using a computer device. The video display method according to the embodiment of the present technology will be described with reference to FIG. 12. FIG. 12 is a flowchart illustrating an example of a procedure of the video display method according to the embodiment of the present technology.

As illustrated in FIG. 12, first, in step S1, the computer device obtains identification information for identifying a user.

Next, in step S2, the computer device obtains position information including a position of a head of the user.

Finally, in step S3, the computer device projects video light associated with the identification information toward the position.

The video display method according to the present embodiment may use the technology according to the other embodiments described above. Therefore, no description will be given below of the technology described in the above-described embodiments.

### 9. Example of the Present Technology

An example of the present technology will be described. Note that the content described below is an example, and there may be another example.

### [(1) Digital Signage]

The video display device 10 (including the video display system 1000, the same applied hereinafter) according to an embodiment of the present technology can be used as a digital signage, for example.

For example, at a station or the like, the video display device 10 can provide, to the user, a video including operation information associated with the user. The video display device 10 can provide, to the user, a video including operation information regarding a commuting route of the user, for example. The video may be displayed with the video superimposed on a route map. The video display device 10 can further provide, to the user, a video including the operation information in the language the user uses (such as English, Chinese, or Korean).

For example, in an outdoor festival or the like, the video display device 10 can provide, to the user, a video including information regarding an artist associated with the user. The video display device 10 can provide, to the user, a video including information regarding a schedule of an artist in which the user is interested, for example. The video may be displayed with the video superimposed on a map of a place where the outdoor festival takes place. Alternatively, the video display device 10 can provide a special video to a specific user.

For example, at a shop or the like, the video display device 10 can provide, to the user, a video including product information associated with the user. For example, the video display device 10 can provide, to the user, a video including information regarding where a product to be purchased by the user is placed. The video may be displayed with the video superimposed on a floor map of the shop.

For example, at a restaurant or the like, the video display device 10 can provide, to the user, a video including food information associated with the user. The video display device 10 can provide, to the user, a video including, for example, food information regarding a food allergy the user has, food information regarding food the user likes, or the like. The video may be displayed with the video superimposed on a menu.

### [(2) Agent]

The video display device 10 according to an embodiment of the present technology can be used as, for example, an agent.

For example, the video display device 10 provided in a robot or the like can provide, to the user, a video including information associated with the user. The video display device 10 can prevent another person from stealing a glance at the video.

For example, at a cafe or the like, the video display device 10 can provide, to the user, a video including a chat screen, a mail screen, or the like regarding the user.

For example, at a reception space of a company or the like, the video display device 10 can provide, to the user, a video including information regarding a partner the user visits.

For example, at a commercial display space or the like, the video display device 10 can provide, to the user, a video including information according to the user.

For example, while the user is riding a bicycle or is at a workout gym, the video display device 10 can provide, to the user, a video without obstructing the view of the user.

For example, while the user is using a smartphone terminal, a PC, or the like, the video display device 10 can provide, to the user, a video as a subscreen.

Alternatively, the video display device 10 can be used as, for example, an intelligent speaker.

### [(3) Security]

The video display device 10 according to an embodiment of the present technology can be used as, for example, a system for which high security requirements need to be satisfied.

The video display device 10 can be used, for example, to prompt the user to enter personal information. The video display device 10 can provide, to the user, a video including information necessary for entering personal information. As a specific example, the video display device 10 can be used for filling in a document at a city hall, filling in a medical questionnaire at a hospital, a signature certifying receipt of a home delivery package, a credit card signature given at a checkout of a shop, business negotiations at a cafe, business records of a sales representative, or the like.

The video display device 10 can be used, for example, to prompt the user to enter a personal identification number. The video display device 10 can provide, to the user, a video in which numbers necessary for entering the personal identification number are randomly arranged, for example. As a specific example, the video display device 10 can be used for an automated teller machine (ATM) at a bank, credit card payment at a checkout of a shop, a coin-operated locker at a station or the like, unlocking a smartphone terminal or the like, or the like.

The video display device 10 can be used, for example, to prompt the user to enter information necessary for paying a usage fee. The video display device 10 can provide, to the user, a video including the personal information regarding the user and a video in which the numbers necessary for entering the personal identification number are randomly arranged with both the videos superimposed on each other. As a specific example, the video display device 10 can be used for a reception machine or a checkout machine at a medical institution, an information terminal or a checkout machine at a shop, a checkout machine at a leisure facility, or the like.

Alternatively, the configurations described in the above-described embodiments can be selected or changed as needed to other configurations without departing from the gist of the present technology.

Note that the effects described herein are merely examples and should not be restrictively interpreted, and other effects may be provided.

Note that the present technology may have the following configurations.

[1]

A video display device including a video projection unit configured to obtain identification information for identifying a user and position information including a position of a head of the user and project video light associated with the identification information toward the position.

[2]

The video display device according to [1], in which the video light is projected onto a pupil of the user.

[3]

The video display device according to [1] or [2], in which the video light is coherent light.

[4]

The video display device according to any one of [1] to [3], in which

the video light is laser light.

[5]

The video display device according to any one of [1] to [4], in which

the video projection unit obtains the position information on the basis of a captured image including the user.

[6]

The video display device according to any one of [1] to [5], in which

the video projection unit obtains the position information on the basis of a difference between a transmission time of infrared light transmitted toward the user and a reception time of the infrared light reflected.

[7]

The video display device according to any one of [1] to [6], in which

the video projection unit adjusts, on the basis of the position information, an angle of an optical axis of the video light and projects the video light.

[8]

The video display device according to any one of [1] to [7], further including

an eyepiece optical unit including an optical element configured to concentrate the video light to project the video light onto a pupil of the user.

[9]

The video display device according to [8], in which

the eyepiece optical unit includes a tag including the identification information.

[10]

The video display device according to [8] or [9], in which

the optical element includes a diffraction grating configured to diffract the video light.

[11]

The video display device according to any one of [8] to [10], in which

the optical element is positioned on an optical axis of the video light.

[12]

The video display device according to any one of [8] to [11], in which

the eyepiece optical unit is mounted on the head of the user.

[13]

The video display device according to any one of [8] to [12], in which

the eyepiece optical unit is carried by the user.

[14]

The video display device according to any one of [8] to [13], in which

the video projection unit adjusts, on the basis of characteristic information regarding characteristics of the optical element, an angle of an optical axis of the video light and projects the video light.

[15]

The video display device according to any one of [1] to [14], in which

the video projection unit includes a video display unit configured to display a video on a screen, and

a virtual image reproduced by the video light projected onto a pupil of the user is displayed with the virtual image superimposed on the screen.

[16]

A video display system including:

a video projection unit configured to obtain identification information for identifying a user and position information including a position of a head of the user and project video light associated with the identification information toward the position; and

an eyepiece optical unit including an optical element configured to concentrate the video light to project the video light onto a pupil of the user, in which

the video projection unit and the eyepiece optical unit are disposed separately from each other.

[17]

The video display system according to [16], in which

each of a plurality of the video projection units is connected over an information communication network, and

the identification information and/or information regarding the video light are/is communicated over the information communication network.

[18]

A video display method including obtaining identification information for identifying a user and position information including a position of a head of the user and projecting video light associated with the identification information toward the position.

### REFERENCE SIGNS LIST

10 Video display device
1 Video projection unit
11 Projection optical system
12 Position information acquisition unit
13 Optical axis adjustment unit
14 Identification information acquisition unit
15 Storage unit
16 Communication unit
17 Control unit
18 Video display unit
2 Eyepiece optical unit
21 Optical element
22 Tag
3 User
4 Video light
5 Virtual image
100 Information communication network
1000 Video display system
S3 Projecting video light associated with identification information

1. A video display device comprising a video projection unit configured to obtain identification information for identifying a user and position information including a position of a head of the user and project video light associated with the identification information toward the position.

2. The video display device according to claim 1, wherein
the video light is projected onto a pupil of the user.

3. The video display device according to claim 1, wherein
the video light is coherent light.

4. The video display device according to claim 1, wherein
the video light is laser light.

5. The video display device according to claim 1, wherein
the video projection unit obtains the position information on a basis of a captured image including the user.

6. The video display device according to claim 1, wherein
the video projection unit obtains the position information on a basis of a difference between a transmission time of infrared light transmitted toward the user and a reception time of the infrared light reflected.

7. The video display device according to claim 1, wherein
the video projection unit adjusts, on a basis of the position information, an angle of an optical axis of the video light and projects the video light.

8. The video display device according to claim 1, further comprising
an eyepiece optical unit including an optical element configured to concentrate the video light to project the video light onto a pupil of the user.

9. The video display device according to claim 8, wherein
the eyepiece optical unit includes a tag including the identification information.

10. The video display device according to claim 8, wherein
the optical element includes a diffraction grating configured to diffract the video light.

11. The video display device according to claim 8, wherein
the optical element is positioned on an optical axis of the video light.

12. The video display device according to claim 8, wherein
the eyepiece optical unit is mounted on the head of the user.

13. The video display device according to claim 8, wherein
the eyepiece optical unit is carried by the user.

14. The video display device according to claim 8, wherein
the video projection unit adjusts, on a basis of characteristic information regarding characteristics of the optical element, an angle of an optical axis of the video light and projects the video light.

15. The video display device according to claim 1, wherein
the video projection unit includes a video display unit configured to display a video on a screen, and
a virtual image reproduced by the video light projected onto a pupil of the user is displayed with the virtual image superimposed on the screen.

16. A video display system comprising:
a video projection unit configured to obtain identification information for identifying a user and position information including a position of a head of the user and project video light associated with the identification information toward the position; and
an eyepiece optical unit including an optical element configured to concentrate the video light to project the video light onto a pupil of the user, wherein
the video projection unit and the eyepiece optical unit are disposed separately from each other.

17. The video display system according to claim 16, wherein
each of a plurality of the video projection units is connected over an information communication network, and
the identification information and/or information regarding the video light are/is communicated over the information communication network.

18. A video display method comprising obtaining identification information for identifying a user and position information including a position of a head of the user and projecting video light associated with the identification information toward the position.
